(19) United States
(12) Patent Application Publication
(10) Pub. No.: US 2024/0169808 A1
(43) Pub. Date: May 23, 2024

(54) AUTOMATED TELLER MACHINE

(71) Applicant: HYOSUNG TNS INC., Seoul (KR)

(72) Inventors: Sung Ho PARK, Seoul (KR); Chun Ho MOON, Seoul (KR); Hyunsung CHUNG, Seoul (KR); Hyun Soo JANG, Seoul (KR)

(21) Appl. No.: 18/515,804

(22) Filed: Nov. 21, 2023

(30) Foreign Application Priority Data
Nov. 23, 2022 (KR) 10-2022-0158472

(51) Int. Cl. G07F 19/00

(52) U.S. Cl. CPC G07F 19/203; G07F 19/202; G07F 19/205

(57) ABSTRACT

An automated teller machine includes: a lower module providing a space for accommodating mediums; and an upper module supported by the lower module and receiving mediums and guiding the mediums to the lower module. The upper module includes: an upper case disposed above the lower module; a main unit including a conveyance path, the main unit being placed in any one of a closed state in which the main unit is drawn in the upper case and an open state in which the main unit is drawn out of the upper case; an opening/closing unit hingedly connected to a lower portion of the main unit to expose the conveyance path to an outside; and a collision avoidance unit preventing the opening/closing unit from colliding with at least one of the upper case and the lower module when the main unit is switched from the open state to the closed state.

### TECHNICAL FIELD

The present disclosure relates to an automated teller machine.

### BACKGROUND

An automated teller machine (ATM) is a device that allows users to perform deposit and withdrawal transactions of mediums such as cash or checks, account transfers, and inquiries without time constraints using a cash card, a bankbook or the like issued by a financial institution, and is widely used in the financial industry to quickly process user's financial business.

Such an automated teller machine may include an upper module in which a deposit/withdrawal unit, a temporary storage unit, a discrimination unit, and an upper conveyance path are disposed, and deposit and withdrawal of mediums such as banknotes or checks, discrimination of the mediums, and transfer for the deposit/withdrawal and discrimination of the mediums are performed, and a lower module which supports the upper module, is connected to the upper module, and has therein a plurality of cassettes and a lower conveyance path for storing mediums conveyed from the upper module and transferring the stored mediums to the upper module.

Meanwhile, the upper module may include an upper case disposed above the lower module, a main unit in which the deposit/withdrawal unit, the temporary storage unit, the discrimination unit, and a part of the upper conveyance path are disposed, and is movable to be drawn in and out of the upper case, and an opening/closing unit hingedly connected to the main unit to open/close an opening formed on a lower surface of the unit. In such configuration, the automated teller machine can be operated in a state where the main unit is drawn in the upper case. In addition, when maintenance of the deposit/withdrawal unit, the temporary storage unit, the discrimination unit, and the upper transfer path in the upper module is required, the maintenance of the aforementioned components can be performed after drawing the main unit out of the upper case and rotating the opening/closing unit downward to open the opening in the lower surface of the main unit.

After such maintenance, the main unit should be drawn into the upper case in a state in which the opening/closing unit is rotated upward to close the opening in the lower surface of the main unit. However, a user may draw the main unit into the upper case in a state in which the opening/closing unit is rotated downward, without recognizing that the opening in the lower surface of the main unit is opened without being closed by the opening/closing unit. In this case, the opening/closing unit may collide with one or more of the upper case and the lower module. Accordingly one or more of the main unit, the upper case, and the lower module may be damaged during maintenance or the like.

### PRIOR ART DOCUMENT

(Patent Document 1) Korean Patent Application Publication No. 10-2016-0101531 (2016.08.25)

### SUMMARY

In view of the above, the present disclosure provides an automated teller machine capable of preventing the automated teller machine from being damaged during maintenance or the like.

In accordance with an aspect of the present disclosure, there is provided an automated teller machine including: a lower module providing a space for accommodating mediums; and an upper module supported by the lower module and receiving mediums from a user and guiding the mediums to the lower module; wherein the upper module includes: an upper case disposed above the lower module; a main unit including a conveyance path, the main unit being placed in any one of a closed state in which the main unit is drawn in the upper case and an open state in which the main unit is drawn out of the upper case; an opening/closing unit hingedly connected to a lower portion of the main unit to expose the conveyance path to an outside; and a collision avoidance unit preventing the opening/closing unit from colliding with at least one of the upper case and the lower module when the main unit is switched from the open state to the closed state.

Further, an opening may be formed in a lower surface of the main unit, the opening/closing unit opens and closes the opening, and the opening/closing unit may open the opening to expose the conveyance path to the outside.

Further, the main unit may be configured to be relatively movable with respect to the upper case in a front-rear direction, the opening/closing unit may be rotatably connected to the main unit about a hinge extending in the front-rear directions, and the collision avoidance unit may rotate the opening/closing unit so that the opening/closing unit closes the opening when the main unit is switched from the open state to the closed state.

Further, the opening/closing unit may rotate in an up-down direction to open and close the opening, and the collision avoidance unit may include a rotation guide member one end portion of which is rotatably supported by the main unit, and the other end portion of which rotates upward while supporting the opening/closing unit to rotate the opening/closing unit upward when the main unit is switched from the open state to the closed state.

Further, the one end portion of the rotation guide member may be rotated about a rotation axis extending along a direction different from a direction in which the hinge of the opening/closing unit extends.

Further, an auxiliary roller may be connected to one or more of one side and the other side of the rotation guide member.

Further, the collision avoidance unit may further include a rotation auxiliary member disposed on at least one of the upper case and the lower module to assist rotation of the rotation guide member.

Further, the collision avoidance unit may further include a rotation guide roller connected to the opening/closing unit, and the rotation guide member may include a plate-shaped roller contact portion provided on the other side of the rotation guide member to contact the rotation guide roller; and a roller guide portion for guiding the rotation guide roller to prevent the rotation guide roller from being separated from the rotation guide member.

Further, the collision avoidance unit may further include an elastic member for position maintaining both sides of which are respectively connected to the main unit and the opening/closing unit, and which applies an elastic force to the opening/closing unit so that the opening/closing unit is located higher than the other end portion of the rotation guide member when the opening/closing unit opens the opening.

Further, the collision avoidance unit may further include a contact buffering member which is hingedly connected to the opening/closing unit and to one side of which the rotation guide roller is connected, and an elastic member for contact buffering connected to the other side of the contact buffering member and the opening/closing unit.

Further, the main unit may include: a main unit frame in which a component accommodating space is formed and the opening is formed on a lower surface thereof; a deposit/withdrawal unit, disposed in the component accommodation space, through which mediums are deposited and withdrawn; a discriminating unit disposed in the component accommodating space and configured to discriminate mediums; and a first upper conveyance path disposed in the component accommodation space and connected to the deposit/withdrawal unit and the discrimination unit, the mediums being conveyed through the first upper conveyance path, and wherein the opening/closing unit may include: an opening/closing unit frame hingedly connected to a lower portion of the main unit frame to open and close the opening; and a second upper conveyance path disposed on the opening/closing unit frame and connected to the first upper conveyance path.

Further, the main unit may further include a temporary storage unit disposed in the component accommodation space, configured to temporarily store the mediums and connected to the first upper conveyance path.

According to embodiments of the present disclosure, in the configuration that the upper module of the automated teller machine includes the upper case, the main unit in which the deposit/withdrawal unit and the like are disposed and which is placed in any one of a closed state in which the main unit is drawn in the upper case, and an open state in which the main unit is drawn out of the upper case, and the opening/closing unit for opening and closing the opening in the lower surface of the main unit, even when the main unit is switched from the open state to the closed state while the opening/closing unit opens the opening, it is possible to prevent the opening/closing unit from colliding with one of the upper case and the lower module.

In addition, according to embodiments of the present disclosure, it is possible to prevent the automated teller machine from being damaged during maintenance or the like.

### BRIEF DESCRIPTION OF THE DRAWINGS

FIG. 1 is a side view schematically showing the configuration of an automated teller machine according to one embodiment of the present disclosure, which shows a closed state in which a main unit of an upper module is drawn in an upper case.

FIG. 2 is a side view schematically showing an open state in which the main unit of the upper module of the automated teller machine is drawn out of the upper case according to one embodiment of the present disclosure.

FIG. 3 is a front view schematically showing the open state in which the main unit of the upper module of the automated teller machine is drawn out of the upper case according to one embodiment of the present disclosure.

FIG. 4 is a perspective view showing a main unit frame of the main unit of the automated teller machine, an opening/closing unit frame of an opening/closing unit, and a collision avoidance unit of the automated teller machine according to one embodiment of the present disclosure, in which a part of a second upper conveyance path is removed from the opening/closing unit frame.

FIG. 5 is an exploded perspective view of the collision avoidance unit of the automated teller machine according to one embodiment of the present disclosure.

FIGS. 6 to 9 show that when the main unit is switched from the open state to the closed state while the opening/closing unit of the automated teller machine according to one embodiment of the present disclosure opens an opening in a lower surface of the main unit, the opening/closing unit is rotated by the collision avoidance unit to close the opening of the lower surface of the main unit and the opening/closing unit does not collide with any one of the upper case and a lower module.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, or ‘contacted’ with another element, it should be understood that the element may be directly connected to, supported by, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as upper portion, upward, lower portion, downward, up and down, front and back, left side, and right side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

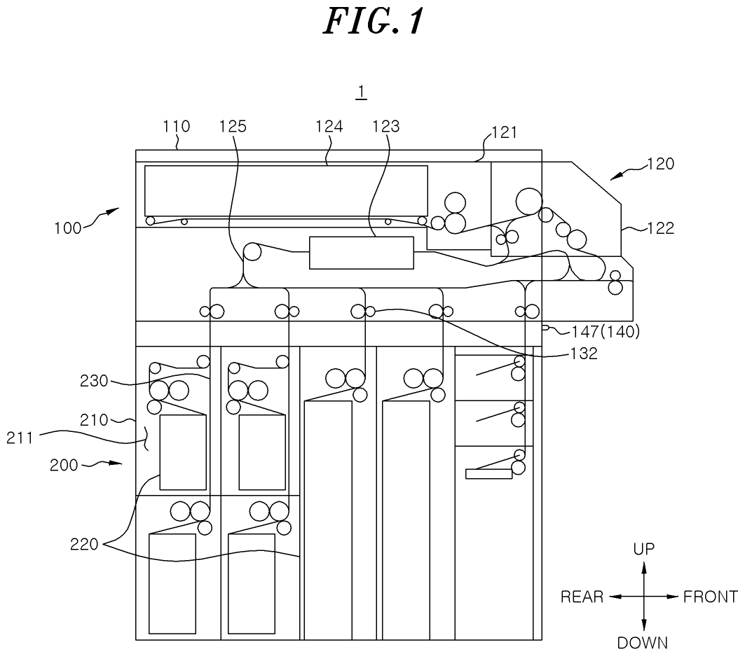

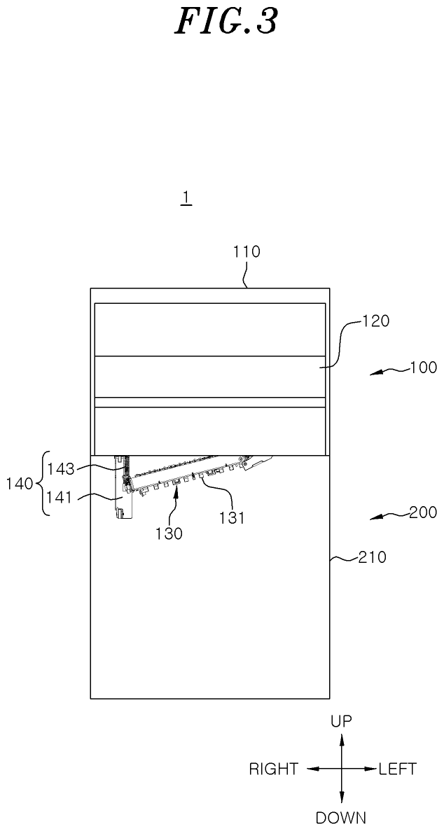

Hereinafter, a specific configuration of an automated teller machine 1 according to one embodiment of the present disclosure will be described with reference to FIGS. 1 to 5.

When a medium (not shown) such as cash or check is deposited, the automated teller machine 1 according to one embodiment of the present disclosure discriminates the type of medium and whether or not there is an abnormality, and then stores the medium having no abnormality for each type and returns the medium having abnormality to a customer. In addition, the automated teller machine 1 withdraws stored mediums having no for each type to a customer. Referring to FIGS. 1 to 3, the automated teller machine 1 may include an upper module 100 and a lower module 200.

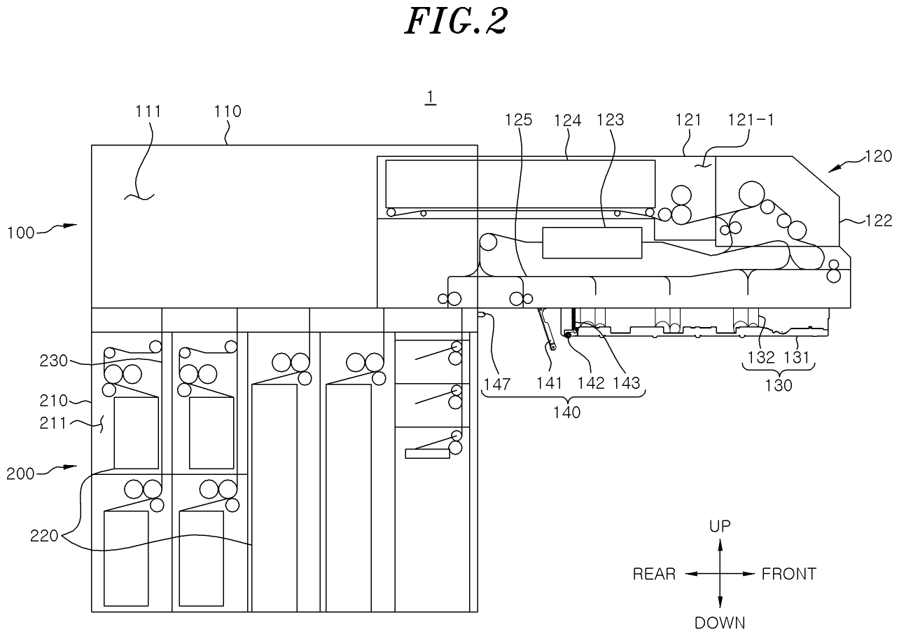

The upper module 100 is supported by the lower module 200 and may be connected to the lower module 200. The upper module 100 may receive a medium such as cash or check from a user and guide it to the lower module 200. In the upper module 100, the deposit of mediums such as cash or checks, and discrimination of the types of mediums and whether or not there is an abnormality may be made. In addition, in the upper module 100, after discrimination, mediums with defects may be returned to a customer, and mediums with no defects stored in the lower module 100 for each type may be withdrawn to a customer. Referring to FIGS. 1 and 2, the upper module 100 may include an upper case 110, a main unit 120, an opening/closing unit 130, and a collision avoidance unit 140.

The upper case 110 may be disposed above the lower module 200. For example, the upper case 110 may be disposed on a lower case 210 to be described later included in the lower module 200. A unit accommodating space 111 may be formed in the upper case 110. Since the main unit 120 moves to the upper case 110 to be drawn in the upper case 110, at least a part of the main unit 120 can be accommodated in the unit accommodating space 111 of the upper case 110. That is, the main unit 120 may be placed in a closed state. In addition, the main unit 120, at least a part of which is accommodated in the unit accommodating space 111 of the upper case 110, moves from the upper case 110 to be drawn out of the upper case 110, so that the main unit 120 may come out of the unit accommodating space 111 of the case 110. That is, the main unit 120 may be placed in an open state. Meanwhile, a rotation auxiliary member 147 may be disposed in the upper case 110 to assist rotation of a rotation guide member 141 to be described later included in the collision avoidance unit 140.

The main unit 120 may be placed in any one of the closed state in which the main unit 120 is drawn in the upper case 110 and the open state drawn out of the upper case 110. The main unit 120 is configured to be movable relative to the upper case 110 in a front-rear direction, and may be placed in any one of the closed state in which the main unit 120 is drawn in the upper case 110 and the open state in which the main unit 120 is drawn out of the upper case 110. For example, an extendable/contractible sliding rail (not shown) including a plurality of rail members (not shown) having different sizes connected to each other is connected to each of an inner surface of the upper case 110 and an outer surface of the main unit 120, so that the main unit 120 can move relative to the upper case 110 in the front-rear direction. However, the configuration in which the main unit 120 moves relative to the upper case 110 in the front-rear direction is not particularly limited.

An opening 121-2 may be formed in a lower surface of the main unit 120.

The opening 121-2 in the lower surface of the main unit 120 may be opened and closed by the opening/closing unit 130 hingedly connectedly connected to the lower surface of the main unit 120. In the open state in which the main unit 120 is drawn out of the upper case 110, the opening/closing unit 130 may be rotated in one direction to open the opening 121-2 in the lower surface of the main unit 120. For example, the opening 121-2 in the lower surface of the main unit 120 may be opened by rotating the opening/closing unit 130 downward. In this way, the opening 121-2 in the lower surface of the main unit 120 is opened by rotating the opening/closing unit 130 downward, and a first upper conveyance path 125 to be described later included in the main unit 120 may be exposed to the outside. In addition, a second upper conveyance path 132 to be described later included in the opening/closing unit 130 may also be exposed to the outside. In this way, in the state in which the opening 121-2 in the lower surface of the main unit 120 is opened by rotating the opening/closing unit 130 downward and the first and second upper conveyance paths 125 and 132 are exposed to the outside, maintenance may be performed not only on the first and second upper conveyance paths 125 and 132, but also on the deposit/withdrawal unit 122 included in the main unit 120, which will be described later. For example, in the state in which the opening 121-2 in the lower surface of the main unit 120 is opened by rotating the opening/closing unit 130 downward to expose the first and second upper conveyance paths 125 and 132 to the outside, a medium caught in the first and second upper conveyance paths 125 and 132 can be removed.

After the maintenance of the main unit 120 is completed, the opening 121-2 in the lower surface of the main unit 120 may be closed by rotating the opening/closing unit 130 in another direction opposite to one direction. For example, the opening 121-2 in the lower surface of the main unit 120 may be closed by rotating the opening/closing unit 130 upward. When the main unit 120 is drawn in the upper case 110 to be in the closed state, it may be connected to the lower module 200. For example, the main unit 120 may be connected to the lower case 210 of the lower module 200 in the closed state in which the main unit 120 is drawn in the upper case 110. Accordingly, mediums such as banknotes or checks can be conveyed between the main unit 120 and the lower module 200. Referring to FIGS. 1 and 2, the main unit 120 may include a main unit frame 121, a deposit/withdrawal unit 122, a discrimination unit 123, a temporary storage unit 124, and a first upper conveyance path 125.

The main unit frame 121 may form an appearance of the main unit 120. The main unit frame 121 may be moved with respect to the upper case 110 along the front-rear direction to be drawn in or out of the unit accommodating space 111 of the upper case 110. By the movement of the main unit frame 121, the main unit 120 may be placed in any one of the closed state in which the main unit is drawn in the upper case 110 and the open state. For example, the sliding rail described above is connected to each of an inner surface of the unit accommodating space 111 of the upper case 110 and the outer surface of the main unit frame 121, so that the main unit frame 121 moves with respect to the upper case 110 along the front-rear direction to be drawn in or out of the unit accommodating space 111 of the upper case 110. However, the configuration in which the main unit frame 121 moves relative to the upper case 110 in the front-rear direction is not particularly limited. A component accommodating space 121-1 may be formed in the main unit frame 121. The deposit/withdrawal unit 122, the discrimination unit 123, the temporary storage unit 124, and the first upper conveyance path 125 may be accommodated in the component accommodation space 121-1. The above-described opening 121-2 may be formed in a lower surface of the main unit frame 121. The opening 121-2 in the lower surface of the main unit frame 121 may be opened and closed by an opening/closing unit frame 131 to be described later which is hingedly connected to a lower part of the main unit frame 121, and included in the opening/closing unit 130. The main unit frame 121 may be formed by connecting a plurality of frame members (not shown) to each other.

The deposit/withdrawal unit 122 may be disposed in the component accommodating space 121-1 of the main unit frame 121. In addition, the deposit/withdrawal unit 122 may provide a deposit/withdrawal space for depositing/withdrawal of mediums such as banknotes or checks. Further, a belt, a roller, a motor, and the like for transferring mediums such as banknotes or checks may be provided in the deposit/withdrawal unit 122. The configurations of the belt, the roller, the motor, and the like are general matters in transferring mediums such as banknotes or checks, and thus detailed descriptions thereof will be omitted.

The discrimination unit 123 may be disposed in the component accommodating space 121-1 of the main unit frame 121. In addition, the discrimination unit 123 may be installed on the first upper conveyance path 125. The discrimination unit 123 may discriminate the types and abnormalities of the mediums such as banknotes or checks moving along the first upper conveyance path 125. When counting mediums deposited by a customer, the normal mediums discriminated as a non-defective medium by the discrimination unit 123 may be temporarily stored in the temporary storage unit 124, and suspicious mediums discriminated as a defective medium by the discrimination unit 123 may be conveyed through the deposit/withdrawal unit 122 to be returned to the customer.

The temporary storage unit 124 may be disposed in the component accommodating space 121-1 of the main unit frame 121. In addition, the temporary storage unit 124 may provide a storage space in which mediums such as banknotes or checks discriminated by the discrimination unit 123 may be temporarily stored. The temporary storage unit 124 may be connected to the first upper conveyance path 125 and receive the mediums discriminated through the discrimination unit 123 through the first upper conveyance path 125.

The first upper conveyance path 125 may be disposed in the component accommodating space 121-1 of the main unit frame 121. The first upper conveyance path 125 may provide a conveyance path of mediums to the component accommodating space 121-1 of the main unit frame 121 of the main unit 120. The first upper conveyance path 125 may provide a path along which mediums deposited and withdrawn through the deposit/withdrawal unit 122 move. For example, the first upper conveyance path 125 may guide the medium deposited through the deposit/withdrawal unit 122 to the discrimination unit 123, the temporary storage unit 124, and a cassette 220 to be described later included in the lower module 200, or guide the medium discharged from the cassette 220 to the discriminating unit 123 and the deposit/withdrawal unit 122. To this end, the first upper conveyance path 125 may be connected to the deposit/withdrawal unit 122 and the discrimination unit 123. In addition, the first upper conveyance path 125 may be connected to the temporary storage unit 124. Further, the first upper conveyance path 125 may be connected to the second upper conveyance path 132 of the opening/closing unit 130. Furthermore, the first upper conveyance path 125 may be connected to a lower conveyance path 230 to be described later included in the lower module 200.

The opening/closing unit 130 may be hingedly connected to the lower part of the main unit 120 so that the conveyance path included in the main unit 120 is exposed to the outside. For example, the opening/closing unit 130 may be hingedly connected to the lower part of the main unit 120 so that the first upper conveyance path 125 of the main unit 120 is exposed to the outside. The opening/closing unit 130 may open and close the opening 121-2 in the lower surface of the main unit 120. As described above, when the main unit 120 is configured to be movable relative to the upper case 110 in the front-rear direction, the opening/closing unit 130 may be connected to the main unit 120 to be rotatable about a hinge extending in the front-rear direction. For example, the main unit 120 may move in the front-rear direction, and a left or right side of the opening/closing unit 130 may be hingedly connected to a left or right side of the lower part of the main unit 120. In addition, the opening/closing unit 130 may rotate upward and downward to open and close the opening 121-2 in the lower surface of the main unit 120. That is, the opening/closing unit 130 may rotate downward to open the opening 121-1 in the lower surface of the main unit 120 in the state in which the opening/closing unit 130 closes the opening 121-1 in the lower surface of the main unit 120. In addition, the opening/closing unit 130 may rotate upward to close the opening 121-1 in the lower surface of the main unit 120 in the state in which the opening/closing unit 130 opens the opening 121-1 in the lower surface of the main unit 120.

When the opening/closing unit 130 opens the opening 121-1 in the lower surface of the main unit 120, the first upper conveyance path 125 of the main unit 120 may be exposed to the outside. In addition, when the opening/closing unit 130 opens the opening 121-1 in the lower surface of the main unit 120, the second upper conveyance path 132 of the opening/closing unit 130 may also be exposed to the outside. In this way, in the state in which the opening/closing unit 130 opens the opening 121-2 in the lower surface of the main unit 120 and the first and second upper conveyance paths 125 and 132 are exposed to the outside, maintenance of the deposit/withdrawal unit 122 of the main unit 120 as well as the first and second upper conveyance paths 125 and 132 may be performed. For example, in the state in which the opening/closing unit 130 opens the opening 121-2 in the lower surface of the main unit 120 to expose the first and second upper conveyance paths 125 and 132 to the outside, a medium caught in the first and second upper conveyance paths 125 and 132 can be removed.

Meanwhile, when the main unit 120 is switched from the open state to the closed state in the state in which the opening/closing unit 130 is rotated downward to open the opening 121-1 in the lower surface of the main unit 120, the main unit 120 may collide with at least one of the upper case 110 and the lower module 200, and at least one of the main unit 120, the upper case 110, and the lower module 200 may be damaged. To prevent this, the automated teller machine 1 according to one embodiment of the present disclosure may include a collision avoidance unit 140.

The opening/closing unit 130 may include an opening/closing unit frame 131 and a second upper conveyance path 132. The opening/closing unit frame 131 may be hingedly connected to the lower part of the main unit frame 121 to open and close the opening 121-2 in the lower surface of the main unit frame 121. As described above, when the main unit frame 121 moves with respect to the upper case 110 along the front-rear direction, the opening/closing unit frame 131 may be rotatably attached to the main unit 120 about a hinge extending in the front-rear direction. For example, the main unit frame 121 moves in the front-rear direction, and a left or right side of the opening/closing unit frame 131 may be hingedly connected to the left or right side of the lower part of the main unit frame 121. In addition, the opening/closing unit frame 131 may open and close the opening 121-2 in the lower surface of the main unit frame 121 by rotating in the up-down direction. That is, the opening/closing unit frame 131 rotates downward in the state in which the opening/closing unit frame 131 closes the opening 121-1 in the lower surface of the main unit frame 121, so that the opening/closing unit frame 131 may open the opening 121-1 in the lower surface of the main unit frame 121. In addition, the opening/closing unit frame 131 rotates upward in the state in which the opening/closing unit frame 131 opens the opening 121-1 in the lower surface of the main unit frame 121, so that the opening/closing unit frame 131 may close the opening 121-1 in the lower surface of the main unit frame 121. Although not indicated with separate reference numerals, a hinge connecting hole may be formed in each of the opening/closing unit frame 131 and the lower part of the main unit frame 121, and a hinge connecting member may extend through each hinge connecting hole, so that the opening/closing unit frame 131 may be hingedly connected to the lower part of the main unit frame 121. In this case, as described above, the hinge extending in the front-rear direction so that the opening/closing unit frame 131 is rotatably connected to the main unit 120 may be the above-described hinge connection member. Meanwhile, the second upper conveyance path 132 may be disposed on the opening/closing unit frame 131. In addition, the second upper conveyance path 132 may be connected to the first upper conveyance path 125. Further, the second upper conveyance path 132 may be connected to the lower conveyance path 230 of the lower module 200.

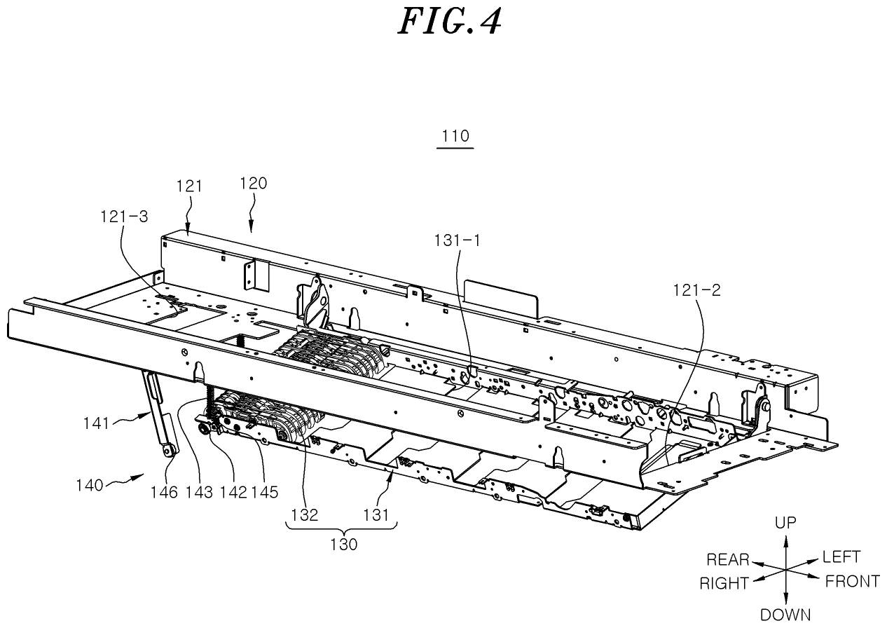

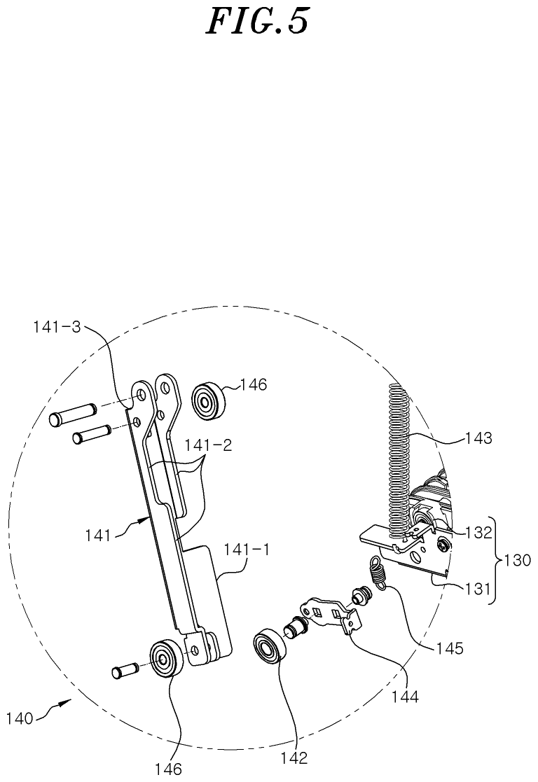

When the main unit 120 is switched from the open state in which the main unit 120 is drawn out of the upper case 110 to the closed state in which the main unit 120 is drawn in the upper case 110, the collision avoidance unit 140 may prevent the opening/closing unit 130 from colliding with any one of the upper case 110 and the lower module 200. To this end, when the main unit 120 is switched from the open state to the closed state, the collision avoidance unit 140 may rotate the opening/closing unit 130 so that the opening/closing unit 130 closes the opening 121-1 in the lower surface of the main unit 120. For example, when the main unit 120 is switched from the open state to the closed state, the collision avoidance unit 140 may rotate the opening/closing unit 130 upward to close the opening 121-1 in the lower surface of the main unit 120. Referring to FIGS. 4 and 5, the collision avoidance unit 140 may include a rotation guide member 141, a rotation guide roller 142, an elastic member 143 for position maintaining, a contact buffering member 144, an elastic member 145 for contact buffering, and an auxiliary roller 146, and a rotation auxiliary member 147.

One end portion of the rotation guide member 141 may be rotatably supported by the main unit 120. For example, the one end portion of the rotation guide member 141 is hingedly connected to the lower part of the main unit frame 121 of the main unit 120 to be rotatably supported by the main unit 120. In this case, although not indicated by separate reference numerals, a hinge connection hole may be formed in each of the one end portion of the rotation guide member 141 and the lower part of the main unit frame 121, and a hinge connection member may extend through each hinge connection hole, so that the one end portion of the rotation guide member 141 may be hingedly connected to the lower part of the main unit frame 121. With such configurations, when the main unit 120 is switched to the open state, the rotation guide member 141 may rotate downward by its own weight about the one end. Meanwhile, the one end portion of the rotation guide member 141 may be rotated about a rotation axis extending in a direction different from the direction in which the hinge of the opening/closing unit 130 extends. For example, in case that the hinge of the opening/closing unit 130 extends in the front-rear direction as described above, the rotation axis of the rotation guide member 141 may extend in a left-right direction. As described above, when the one end portion of the rotation guide member 141 is hingedly connected to the lower part of the main unit frame 121, the rotation axis of the rotation guide member 141 may be the hinge connection member extending through the hinge connection holes respectively formed in the one end portion of the rotation guide member 141 and the lower part of the main unit frame 121.

When the main unit 120 is switched from the open state to the closed state, the rotation guide member 141 rotates upward while the other end thereof supports the opening/closing unit 130, thereby rotating the opening/closing unit 130 upward. Accordingly, when the main unit 120 is switched from the open state to the closed state, the opening/closing unit 130 is made to close the opening 121-1 in the lower surface of the main unit 120. In this way, since the opening/closing unit 130 closes the opening 121-2 in the lower surface of the main unit 120, even when the main unit 120 is converted from the open state to the closed state, the opening/closing unit 130 does not collide with any one of the upper case 110 and the lower module 200, which prevents the main unit 120, the upper case 110, and the lower module 200 from being damaged.

Referring to FIG. 5, the rotation guide member 141 may include a roller contact portion 141-1 and a roller guide portion 141-2. The roller contact portion 141-1 may be provided at the other side of the rotation guide member 141. Further, the roller contact portion 141-1 may have a plate shape. In this way, the plate-shaped roller contact portion 141-1 can easily come into contact with the rotation guide roller 142 by the rotation of the rotation guide member 141.

The roller guide portion 141-2 may guide the rotation guide roller 142 to prevent the rotation guide roller 142 from being separated from the rotation guide member 141. For example, three roller guide portions 141-2 may be formed in the rotation guide member 141. One of the three roller guide portions 141-2 may be formed in the right side of the rotation guide member 141 at a predetermined height to extend a predetermined distance from the roller contact portion 141-1 in the direction toward one side of the rotation guide member 141. In addition, another roller guide portion 141-2 among the three may be formed in the left side of the rotation guide member 141 at a predetermined height to extend from a portion of the rotation guide member 141 that is a predetermined distance away from the roller contact portion 141-1 to the one end portion of the rotation guide member 141. In addition, the remaining roller guide portion 141-2 of the three may extend from the roller guide portion 141-2 extending from the roller contact portion 141-1 to the one side of the rotation guide member 141, but the roller contact portion may be formed in the right side of the rotation guide member 141 at a height lower than that of the roller guide portion 141-2 extending from the roller contact portion 141-1. Meanwhile, in order to limit the rotation angle of the rotation guide member 141, a stopper 141-3 may be formed in the rotation guide member 141. For example, the stopper 141-3 may be formed at the one end portion of the rotation guide member 141. In addition, when the rotation guide member 141 rotates downward at a predetermined angle by its own weight, the stopper 141-3 of the rotation guide member 141 may be caught in a stop hole (not shown) formed in the lower part of the main unit frame 121 of the main unit 120. In this case, the rotation guide member 141 may be rotated so that the other end thereof is positioned lower than the rotation guide roller 142 by the stopper 141-3.

The rotation guide roller 142 may be connected to the opening/closing unit 130. For example, as will be described later, the contact buffering member 144 is hingedly connected to the opening/closing unit frame 131 of the opening/closing unit 130, and the rotation guide roller 142 is rotatably connected to one side of the contact buffering member 144. In this way, the rotation guide roller 142 may be connected to the opening/closing unit 130. However, the configuration in which the rotation guide roller 142 is connected to the opening/closing unit 130 is not particularly limited.

Both sides of the elastic member 143 for position maintaining may be connected to the main unit 120 and the opening/closing unit 130, respectively. When the opening/closing unit 130 opens the opening 121-2 in the lower surface of the main unit 120, the elastic member 143 for position maintaining may apply an elastic force to the opening/closing unit 130 so that the opening/closing unit 130 is positioned higher than the other end of the rotation guide member 141. For example, in the open state of the main unit 120, when the opening/closing unit 130 rotates downward to open the opening 121-2 in the lower surface of the main unit 120, the elastic force of the elastic member 143 for position maintaining may act upward on the opening/closing unit 130. Accordingly, the elastic member 143 for position maintaining may apply the elastic force to the opening/closing unit 130 so that the opening/closing unit 130 is positioned higher than the other end of the rotation guide member 141. In addition, when the main unit 120 is switched from the open state to the closed state in the state in which the opening/closing unit 130 opens the opening 121-2 in the lower surface of the main unit 120, the rotation guide member 141 may contact the opening/closing unit 130. For example, both sides of the elastic member 143 for position maintaining may be connected to the main unit frame 121 of the main unit 120 and the opening/closing unit frame 131 of the opening/closing unit 130, respectively.

The contact buffering member 144 may be hingedly connected to the opening/closing unit 130 and the rotation guide roller 142 may be connected to one side of the contact buffering member 144. For example, a central portion of the contact buffering member 144 may be hingedly connected to the opening/closing unit frame 131 of the opening/closing unit 130. Although not indicated by separate reference numerals, a hinge connection hole may be formed in each of the central portion of the contact buffering member 144 and the opening/closing unit frame 131, and a hinge connection member may extend through each hinge connection hole, so that the central portion of the contact buffering member 144 may be hingedly connected to the opening/closing unit frame 131. In addition, although not indicated by separate reference numerals, a roller connection hole may be formed in each of one side of the contact buffering member 144 and the rotation guide roller 142, and a roller connection member may extend through each roller connection hole, so that the rotation guide roller 142 may be connected to one side of the contact buffering member 144. In addition, the elastic member 145 for contact buffering may be connected to the other side of the contact buffering member 144 and the opening/closing unit 130. For example, the elastic member 145 for contact buffering may be connected to the opening/closing unit frame 131 of the opening/closing unit 130. With such configurations, even when the rotation guide member 141 rotates upward and contacts the rotation guide roller 142 so that an impact is applied to the rotation guide roller 142, the impact can be buffered by the rotation of the contact buffering member 144 and the elastic force of the elastic member 145 for contact buffering.

The auxiliary roller 146 may be connected to the other side of the rotation guide member 141. Further, the auxiliary roller 146 may also be connected to one side of the rotation guide member 141. Although not indicated by separate reference numerals, a roller connection hole may be formed in each of the other side or one side of the rotation guide member 141 and the auxiliary roller 146, and a roller connection member may extend through each roller connection hole, so that the auxiliary roller 146 may be connected to the other side or one side of the rotation guide member 141. While the main unit 120 is converted from the open state to the closed state, the opening/closing unit 130 can be rotated to close the opening 121-1 in the lower surface of the main unit 120 by the collision avoidance unit 140. In the state in which the opening/closing unit 130 is rotated to close the opening 121-1 in the lower surface of the main unit 120, the auxiliary roller 146 can support the rotation guide member 141 so that the rotation guide member 141 does not directly contact the upper case 110. In other words, the auxiliary roller 146 supports the rotation guide member 141 while being in contact with the upper case 110, thereby preventing the rotation guide member 141 from directly contacting the upper case 110.

The rotation auxiliary member 147 may be disposed on one or more of the upper case 110 and the lower module 200. The rotation auxiliary member 147 may assist rotation of the rotation guide member 141. That is, when the main unit 120 is converted from the open state to the closed state, the rotation guide member 141 may rotate in contact with the rotation auxiliary member 147. A portion of the rotation auxiliary member 147 in contact with the rotation guide member 141 may include a curved surface. With such configurations, contact of the rotation guide member 141 with the rotation auxiliary member 147 and thus rotation of the rotation guide member 141 can be smoothly performed. For example, the rotation auxiliary member 147 may have a roller shape. However, the shape of the rotation auxiliary member 147 is not particularly limited.

The lower module 200 may support the upper module 100. Further, the lower module 200 may be connected to the upper module 100. A first and a second lower module connection hole 121-3 and 131-1 connected to the lower module 200 may be formed in the lower surface of the main unit frame 121 of the main unit 120 of the upper module 100 or in the opening/closing unit frame 131 of the opening/closing unit 130, respectively. The lower module 200 may store mediums such as banknotes or checks sorted in the upper module 100. To this end, the lower module 200 may provide a space in which mediums are accommodated. Meanwhile, the rotation auxiliary member 147 of the collision avoidance unit 140, described above, disposed on the upper case 110 may be disposed on the lower module 200 instead of being disposed on the upper case 110. In this case, the rotation auxiliary member 147 may be disposed on a lower case 210 to be described later included in the lower module 200. The lower module 200 may include a lower case 210, a cassette 220, and a lower conveyance path 230.

A lower accommodating space 211 may be formed in the lower case 210. The cassette 220 and the lower conveyance path 230 may be accommodated in the lower accommodation space 211. The upper case 110 may be disposed on the lower case 210.

The cassette 220 may store mediums such as banknotes or checks conveyed from the upper module 100. The cassette 220 may be provided in plurality. In a part of the plurality of cassettes 220, mediums such as banknotes or checks without abnormalities may be stored for each type. In addition, in the other part of the plurality of cassettes 220, mediums such as banknotes or checks with abnormalities may be stored.

The lower conveyance path 230 may be connected to the first and second upper conveyance paths 125 and 132 of the upper module 100 and the cassette 220. In the upper module 100, mediums such as banknotes or checks may be conveyed to the lower conveyance path 230 through the first and second upper conveyance paths 125 and 132. Mediums such as banknotes or checks conveyed through the lower conveyance path 230 may be stored in the corresponding cassette 220 through the lower conveyance path 230. In addition, mediums such as banknotes or checks stored in the cassette 220 may be conveyed to the deposit/withdrawal unit 122 of the upper module 100 through the lower conveyance path 230 and the first and second upper conveyance paths 125 and 132 to be withdrawn.

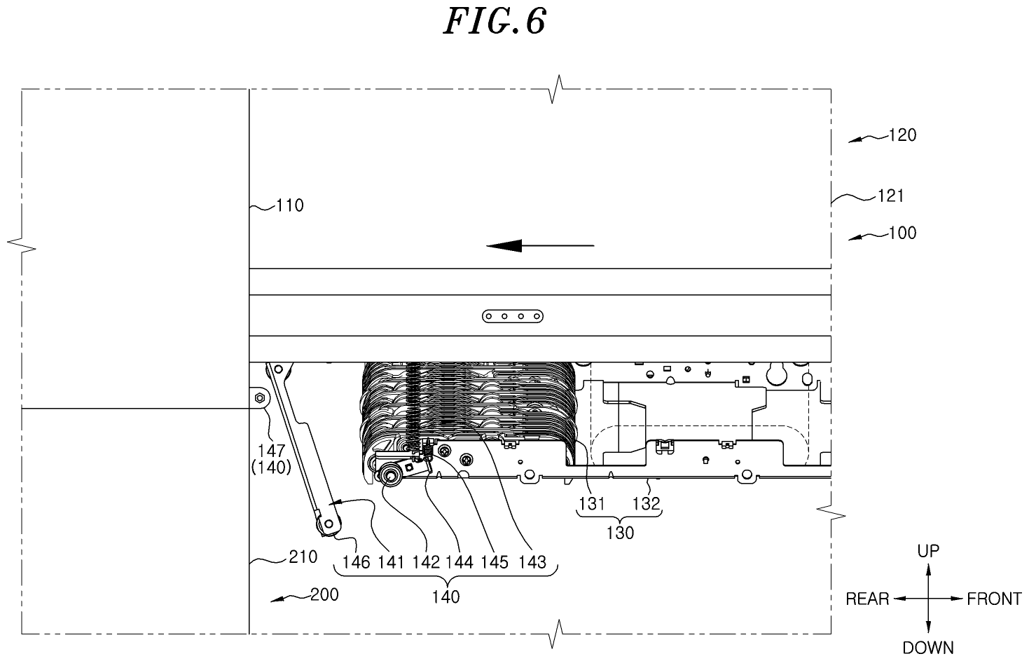

Hereinafter, with reference to FIGS. 6 to 9, the operation and effect of the automated teller machine 1 having the above-described configurations will be described.

When maintenance of the deposit/withdrawal unit 122, the discrimination unit 123, the temporary storage unit 124, or the first upper conveyance path 125 of the main unit 120, or the second upper conveyance path 132 of the opening/closing unit 130 of the upper module 10 is required, the main unit 120 may be drawn out of the upper case 110 of the upper module 100 by moving the main unit 120. That is, the main unit 120 can be switched from the closed state to the open state.

In the open state in which the main unit 120 is drawn out of the upper case 110, the conveyance path of the main unit 120 may be exposed to the outside. By allowing the opening 121-2 in the lower surface of the main unit 120 to be opened by rotating the opening/closing unit 130 downward, the first upper conveyance path 125 of the main unit 120 and the second upper conveyance path 132 of the opening/closing unit 130 may be exposed to the outside. In this way, in the state in which the opening 121-2 in the lower surface of the main unit 120 is opened by the opening/closing unit 130, maintenance of the deposit/withdrawal unit 122, the discrimination unit 123, the temporary storage unit 124, or the first upper conveyance path 125 of the main unit 120, or the second upper conveyance path 132 of the opening/closing unit 130 can be performed. For example, in the state in which the opening 121-2 in the lower surface of the main unit 120 is opened by rotating the opening/closing unit 130 downward and the first and second upper conveyance paths 125 and 132 are exposed to the outside, a medium caught in the first and second upper conveyance paths 125 and 132 can be removed.

When the maintenance of the deposit/withdrawal unit 122, the discrimination unit 123, the temporary storage unit 124, or the first upper conveyance path 125 of the main unit 120, or the second upper conveyance path 132 of the opening/closing unit 130 is complete, after the opening 121-2 in the lower surface of the main unit 120 is closed by the opening/closing unit 130, the main unit 120 may be drawn in the upper case 110. That is, the main unit 120 can be switched from the open state to the closed state.

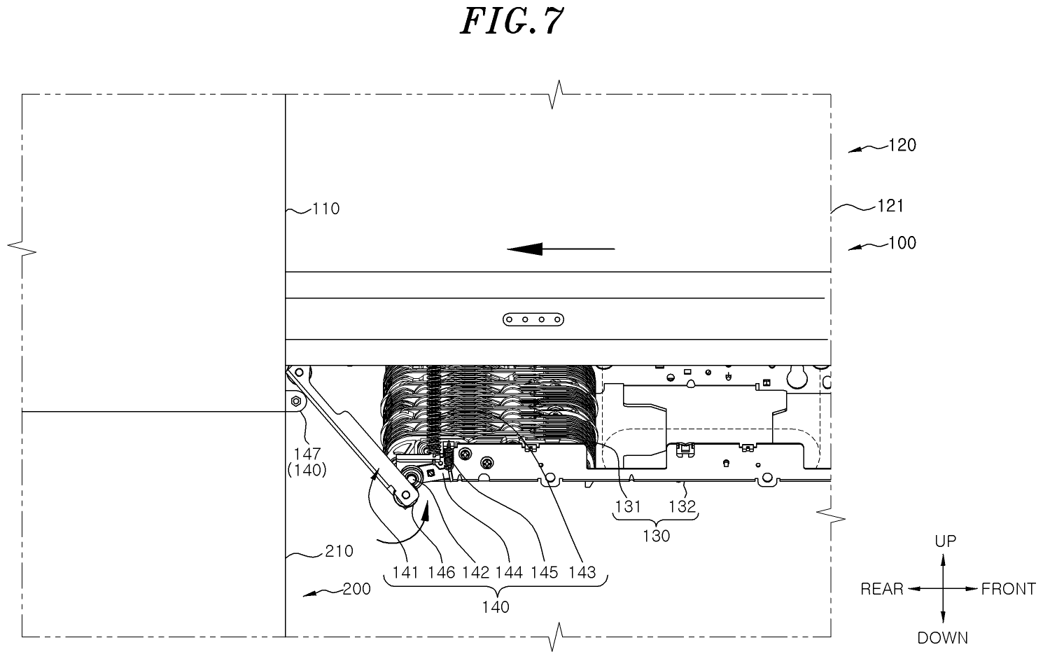

Meanwhile, a user may switch the main unit 120 from the open state to the closed state without recognizing that the opening 121-2 in the lower surface of the main unit 120 is opened by the opening/closing unit 130 rotated downward. In this case, as shown in FIGS. 6 and 7, while the main unit 120 is switched from the open state to the closed state, the rotation guide member 141 of the collision avoidance unit 140 comes in contact with the rotation auxiliary member 147 disposed on at least one of the upper case 110 and the lower module 200, and the rotation guide member 141 can rotate toward the rotation guide roller 142 connected to the opening/closing unit 130. For example, the rotation guide member 141 may rotate upward by being in contact with the rotation auxiliary member 147 disposed on at least one of the upper case 110 and the lower module 200.

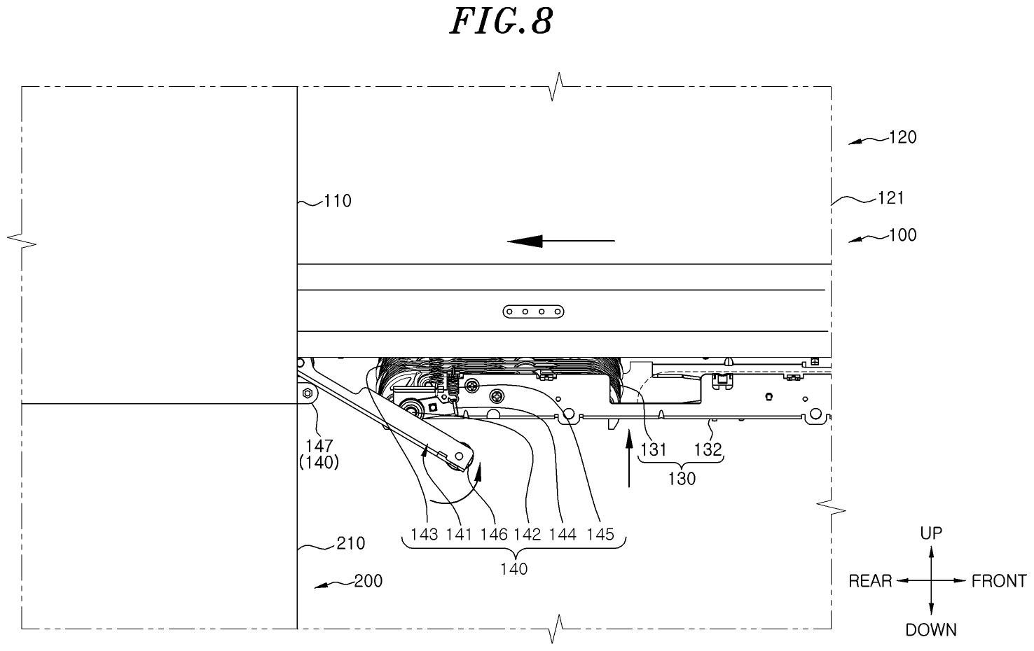

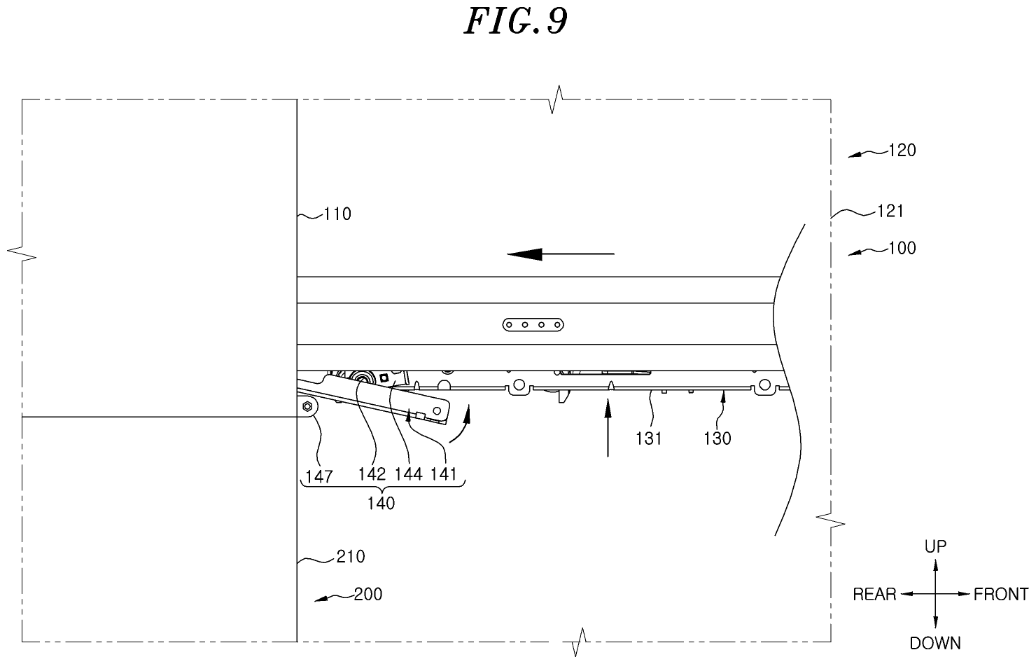

While the main unit 120 continues to switch from the open state to the closed state, the rotation guide member 141 can further rotate and come into contact with the rotation guide roller 142. By this, the rotation guide member 141 can rotate while the other end of the rotation guide member 141 supports the opening/closing unit 130. Accordingly, as shown in FIGS. 8 and 9, the opening/closing unit 130 can rotate in a direction to close the opening 121-2 in the lower surface of the main unit 120. For example, the opening/closing unit 130 rotates upward by the rotation guide member 141 rotating upward, so that the opening/closing unit 130 can close the opening 121-2 in the lower surface of the main unit 120. Therefore, it is possible to prevent the opening/closing unit 130 from colliding with any one of the upper case 110 and the lower module 200. In addition, it is possible to prevent the automated teller machine 1 from being damaged during maintenance or the like.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. An automated teller machine comprising:
a lower module providing a space for accommodating mediums; and
an upper module supported by the lower module and receiving mediums from a user and guiding the mediums to the lower module;
wherein the upper module includes:
an upper case disposed above the lower module;
a main unit including a conveyance path, the main unit being placed in any one of a closed state in which the main unit is drawn in the upper case and an open state in which the main unit is drawn out of the upper case;
an opening/closing unit hingedly connected to a lower portion of the main unit to expose the conveyance path to an outside; and
a collision avoidance unit preventing the opening/closing unit from colliding with at least one of the upper case and the lower module when the main unit is switched from the open state to the closed state.

2. The automated teller machine of claim 1, wherein an opening is formed in a lower surface of the main unit,
the opening/closing unit opens and closes the opening, and
the opening/closing unit opens the opening to expose the conveyance path to the outside.

3. The automated teller machine of claim 2, wherein the main unit is configured to be relatively movable with respect to the upper case in a front-rear direction,
the opening/closing unit is rotatably connected to the main unit about a hinge extending in the front-rear directions, and
the collision avoidance unit rotates the opening/closing unit so that the opening/closing unit closes the opening when the main unit is switched from the open state to the closed state.

4. The automated teller machine of claim 3, wherein the opening/closing unit rotates in an up-down direction to open and close the opening, and
the collision avoidance unit includes a rotation guide member one end portion of which is rotatably supported by the main unit, and the other end portion of which rotates upward while supporting the opening/closing unit to rotate the opening/closing unit upward when the main unit is switched from the open state to the closed state.

5. The automated teller machine of claim 4, wherein the one end portion of the rotation guide member is rotated about a rotation axis extending along a direction different from a direction in which the hinge of the opening/closing unit extends.

6. The automated teller machine of claim 5, wherein an auxiliary roller is connected to one or more of one side and the other side of the rotation guide member.

7. The automated teller machine of claim 4, wherein the collision avoidance unit further includes a rotation auxiliary member disposed on at least one of the upper case and the lower module to assist rotation of the rotation guide member.

8. The automated teller machine of claim 4, wherein the collision avoidance unit further includes a rotation guide roller connected to the opening/closing unit, and
wherein the rotation guide member includes a plate-shaped roller contact portion provided on the other side of the rotation guide member to contact the rotation guide roller; and a roller guide portion for guiding the rotation guide roller to prevent the rotation guide roller from being separated from the rotation guide member.

9. The automated teller machine of claim 4, wherein the collision avoidance unit further includes an elastic member for position maintaining both sides of which are respectively connected to the main unit and the opening/closing unit, and which applies an elastic force to the opening/closing unit so that the opening/closing unit is located higher than the other end portion of the rotation guide member when the opening/closing unit opens the opening.

10. The automated teller machine of claim 8, wherein the collision avoidance unit further includes a contact buffering member which is hingedly connected to the opening/closing unit and to one side of which the rotation guide roller is connected, and an elastic member for contact buffering connected to the other side of the contact buffering member and the opening/closing unit.

11. The automated teller machine of claim 2, wherein the main unit includes:
a main unit frame in which a component accommodating space is formed and the opening is formed on a lower surface thereof;
a deposit/withdrawal unit, disposed in the component accommodation space, through which mediums are deposited and withdrawn;
a discriminating unit disposed in the component accommodating space and configured to discriminate mediums; and
a first upper conveyance path disposed in the component accommodation space and connected to the deposit/withdrawal unit and the discrimination unit, the mediums being conveyed through the first upper conveyance path, and
wherein the opening/closing unit includes:
an opening/closing unit frame hingedly connected to a lower portion of the main unit frame to open and close the opening; and
a second upper conveyance path disposed on the opening/closing unit frame and connected to the first upper conveyance path.

12. The automated teller machine of claim 11, wherein the main unit further includes a temporary storage unit disposed in the component accommodation space, configured to temporarily store the mediums and connected to the first upper conveyance path.
